(19) United States
(12) Patent Application Publication
(10) Pub. No.: US 2020/0322699 A1
(43) Pub. Date: Oct. 8, 2020

(54) CREATION OF INTERACTIVE MEDIA

(71) Applicant: AppOnboard, Inc., Los Angeles, CA (US)

(72) Inventors: Adam Piechowicz, Los Angeles, CA (US); Jonathan Zweig, Santa Monica, CA (US); Bryan Buskas, Sherman Oaks, CA (US); Abraham Pralle, Seattle, WA (US); Sloan Tash, Long Beach, CA (US); Armen Karamian, Los Angeles, CA (US); Rebecca Mauzy, Los Angeles,, CA (US)

(21) Appl. No.: 16/905,778

(22) Filed: Jun. 18, 2020

Related U.S. Application Data
(63) Continuation-in-part of application No. 16/588,500, filed on Sep. 30, 2019.
(60) Provisional application No. 62/819,494, filed on Mar. 15, 2019.

(51) Int. Cl. H04N 21/8545; H04N 21/8541; H04N 21/854

(52) U.S. Cl. CPC H04N 21/8545; H04N 21/85406; H04N 21/8541

(57) ABSTRACT

A method may include obtaining a first video asset with a first number of frames, where the first video asset includes a terminal portion that has at least one frame. The method may also include duplicating the terminal portion of the first video asset. The method may further include appending the duplicated terminal portion at the end of the first video asset as a new first video asset, and splicing the new first video asset with a second video asset to create a single final video.

### RELATED APPLICATIONS

This application is a continuation-in-part of U.S. patent application Ser. No. 16/588,500, filed Sep. 30, 2019, titled STUDIO BUILDER FOR INTERACTIVE MEDIA, which claims priority to U.S. Provisional Application No. 62/819,494, filed Mar. 15, 2019, titled STUDIO BUILDER FOR INTERACTIVE MEDIA, each of which is incorporated herein by reference in their entireties.

### TECHNICAL FIELD

Embodiments of the present disclosure relate to the field of interactive media asset creation, and in particular, to the use of splicing, padding, or other such techniques in the generation of the interactive media.

### BACKGROUND

Interactive media can be difficult to create when more than one source of interactive media is involved. That difficulty can be amplified if the interactive media is to be used in an environment with varying types and styles of hardware and/or software for reproducing the interactive media.

### SUMMARY

One or more embodiments of the present disclosure may include a method that includes obtaining a first video asset with a first number of frames, where the first video asset includes a terminal portion that has at least one frame. The method may also include duplicating the terminal portion of the first video asset. The method may further include appending the duplicated terminal portion at the end of the first video asset as a new first video asset, and splicing the new first video asset with a second video asset to create a single final video.

The present disclosure may also include non-transitory computer-readable media containing instructions to cause a system to perform such a method, and/or a system configured to perform such a method.

The object and advantages of the embodiments will be realized and achieved at least by the elements, features, and combinations particularly pointed out in the claims.

It is to be understood that both the foregoing general description and the following detailed description are merely examples and explanatory and are not restrictive.

### BRIEF DESCRIPTION OF THE DRAWINGS

Example embodiments will be described and explained with additional specificity and detail through the use of the accompanying drawings in which:

FIG. 1 is a diagram illustrating an example system that may be used for generating interactive media;

FIG. 2 illustrates an example application of the system of FIG. 1;

FIG. 3 illustrates various examples of portions of interactive media;

FIG. 4 is a flow diagram illustrating a method of generating an interactive media asset;

FIG. 5 illustrates another example flowchart of another example method of generating an interactive media asset; and

FIG. 6 illustrates an example computing system.

### DETAILED DESCRIPTION

The present disclosure relates to, inter alia, the generation of interactive media. In particular, when generating interactive media, multiple video clips may be combined into a single cohesive video where certain portions of the single cohesive video may be played at certain times depending on the interaction of a user with a mobile device or other computing system playing the single cohesive video. For example, the single video may have a clip showing a person running, a clip of the person falling into a pit, and a clip of the person jumping over the pit. Depending on the user interaction, the interactive media may play, in succession, the person running and then jumping over the pit, or may play the person running and then skip forward in the interactive media to play video of the person falling into the pit. However, when combining multiple video clips, various problems arise. For example, depending on the hardware, when skipping or otherwise navigating to the clip of falling into the pit rather than jumping over the pit, certain frames of the video may be skipped, or inadvertent additional frames leading into an undesired clip may be played (e.g., the video may play a few frames of the person jumping over the pit before the video of the person falling into the pit plays).

To overcome these and other issues, the present disclosure provides various resolutions to these problems. In some embodiments, when combining multiple clips, each of the individual clips combined into the single video may have an initial frame tagged as a key frame in the single video. By doing so, even after combining the clips into a single interactive media asset, the individual clips may be navigated to and played when and as desired.

In some embodiments, various frames of a video clip may be reproduced and added in certain locations to overcome shortcomings in clip navigation within the video. For example, a final frame in a clip may be reproduced as part of the clip. As another example, the initial frame of a clip may be reproduced to facilitate navigating to the start of the clip. As a further example, the final frame may be further reproduced as padding between the clip and a following clip. As explained in greater detail herein, each of these variations may facilitate improvements in the operation and use of an interactive media asset.

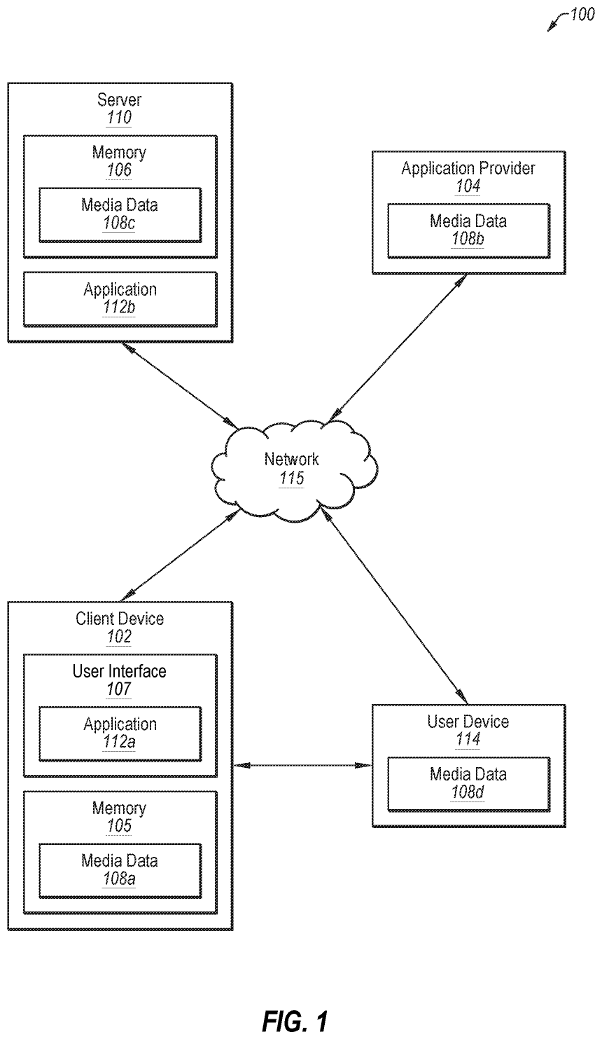

FIG. 1 illustrates an example system 100 that may be used for generating interactive media, in accordance with one or more embodiments of the present disclosure. The system 100 includes a client device 102, a network 115, a server 110, an application provider 104, and a user device 114.

In some embodiments, the network 115 may include a public network (e.g., the Internet), a private network (e.g., a local area network (LAN) or a wide area network (WAN)), a wired network (e.g., an Ethernet network), a wireless network (e.g., an 802.11 network, Bluetooth network, or a Wi-Fi network), a cellular network (e.g., a Long Term Evolution (LTE) or LTE-Advanced network), routers, hubs, switches, server computers, and/or a combination thereof.

The server 110 may include one or more computing devices, such as a rackmount server, a router computer, a server computer, a personal computer, a mainframe computer, a laptop computer, a tablet computer, a desktop computer, etc. The server may include data stores (e.g., hard disks, memories, databases), networks, software components, and/or hardware components. For example, as illustrated in FIG. 1, in some embodiments, the server 110 may include a memory 106.

The user device 114 may include a computing device such as a personal computer (PC), a laptop, a mobile phone, a smart phone, a tablet computer, a netbook computer, an e-reader, a personal digital assistant (PDA), a cellular phone etc. While only a single user device 114 is shown in FIG. 1, the system 100 may include more than one user device 114. For example, in some embodiments, the system 100 may include two or more user devices 114.

The client device 102 may include a computing device such as a personal computer (PC), a laptop, a mobile phone, a smart phone, a tablet computer, a netbook computer, an e-reader, a personal digital assistant (PDA), or a cellular phone etc. While only a single client device 102 is shown in FIG. 1, the system 100 may include more than one client device 102. For example, in some embodiments, the system 100 may include two or more client devices 102. The client device 102 may include a memory 105.

The memory 105 and the memory 106 may be a memory (e.g., random access memory), a cache, a drive (e.g., a hard drive), a flash drive, a database system, or another type of component or device capable of storing data.

The application provider 104 may include one or more computing devices, such as a rackmount server, a router computer, a server computer, a personal computer, a mainframe computer, a laptop computer, a tablet computer, a desktop computer, etc. The application provider 104 may include data stores (e.g., hard disks, memories, databases), networks, software components, and/or hardware components.

In some embodiments, the system 100 may be implemented to create, access, update, transfer, or otherwise perform editing functions of media data 108 via an application 112 provided by a user interface (UI) 107 on the client device 102. For example, the UI 107 may provide access to a first application 112a stored on the client device 102 or a second application 112b stored on the server 110. The first application 112a and the second application 112b are referred to in the present disclosure as the application 112.

The client device 102 may display the application 112 via the UI 107 to a user to guide the user through a process to access, update, transfer, or otherwise perform editing functions of first media data 108a stored in the memory 105 of the client device 102, second media data 108b stored on the application provider 104, third media data 108c stored in the memory 106 of the server 110, fourth media data 108d stored on the user device 114, or any combination thereof including more or fewer data. The first media data 108a, the second media data 108b, the third media data 108c, and the fourth media data 108d are referred to in the present disclosure as the media data 108.

In some embodiments, the application 112 may transfer the fourth media data 108d directly to the user device 114 via over the air communication techniques. In other embodiments, the application 112 may access the media data 108 or transfer the media data 108 to the server 110, the application provider 104, and the user device 114 via the network 115 or directly. For example, the client device 102 may transfer the fourth media data 108d to the user device 114 via over the air communication techniques, for example, using AirDrop® or near-field communications (NFC). As another example, the client device 102 may access the third media data 108c stored in the memory 106 on the server 110 via the network.

In some embodiments, the application 112 may include a web browser that can present media editing functions to a user. As a web browser, the application 112 may also access, retrieve, present, and/or navigate content (e.g., web pages such as Hyper Text Markup Language (HTML) pages, digital media items, etc.) via the network. The application 112 may render, display, and/or present the media editing functions and the media data 108 to the user. In another example, the application 112 may include a standalone application (e.g., a mobile application or mobile app) that allows users to perform editing functions of the media data 108. Likewise, in yet another example, the application 112 may permit a user of the client device 102 to transfer at least a portion of the media data 108 to the server 110, the application provider 104, the user device, and/or any combinations thereof.

The media data 108 may include electronic content such as pictures, videos, graphic interchange formats (GIFs), or any other appropriate electronic content. The media data 108 may be obtained by a video camera, a smart phone, or any other appropriate device for obtaining media (not shown). Additionally, the media data 108 may include a demonstration of a game, an application, or another feature for a mobile device or another electronic device. In some embodiments, the media data 108 may include video segments that may be spliced together to generate interactive media for demonstrating the game, the application, or the other feature of the mobile device or the electronic device. As another example, the media data 108 may include a training video that permits a user to simulate training exercises via the media data 108. The media data 108 may include an interactive media asset that may include any number and any type of media items that are combined into the interactive media asset.

In some embodiments, the first media data 108a, the second media data 108b, the third media data 108c, and the fourth media data 108d may include the same or similar versions or types of media content. In other embodiments, the first media data 108a, the second media data 108b, the third media data 108c, and the fourth media data 108d may each include different versions or types of media content. In yet another embodiment, the first media data 108a, the second media data 108b, the third media data 108c, and the fourth media data 108d may each include a different portion of an overall version of media content.

During operation of the system 100, the client device may select assets for use in production of an interactive media asset. Using the user interface, video assets, audio assets, image assets, and/or other assets may be combined, organized, and/or arranged to produce an interactive media asset. For example, transitions between assets may be created, including transitions based on touch interaction or any other interaction or input. In some embodiments, the completed interactive media asset may be sent to and/or received by the user device 114. The user device 114 may execute code of the interactive media (e.g. in an application).

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any number of media data 108 may be utilized or combined into the interactive media asset.

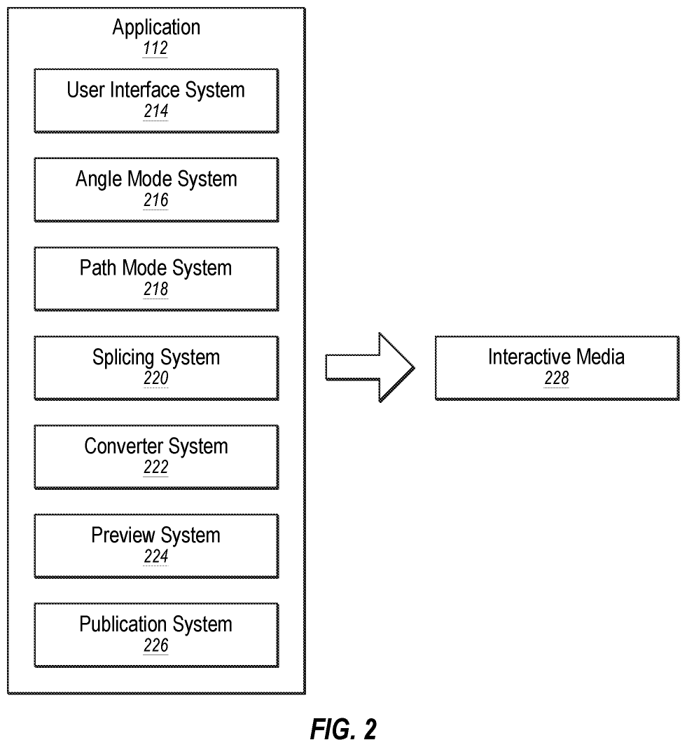

FIG. 2 is a block diagram illustrating an example application 112 of the system 100 of FIG. 1, in accordance with one or more embodiments of the present disclosure. The application 112 may be implemented to generate interactive media 228, which may include the interactive media asset and/or the media data 108 of FIG. 1. The application 112 may include a user interface system 214, a path mode system 218, a splicing system 220, a converter system 222, a preview system 224, and a publication system 226. More or less the various systems may be included in the application 112 without loss of generality. For example, some of the systems may be combined into a single system, or any of the systems may be divided into two or more systems. In one implementation, one or more of the systems may reside on different computing devices (e.g., different server computers).

The application 112 may combine media assets, such as video assets, audio assets, and image assets, to produce an interactive media asset. Using the application 112, transitions between scenes of the interactive media may be defined based on playback of videos ending, playback of audio ending, receiving input in the form of gestures, counters, amount of time elapsed, etc., and/or any combinations of the foregoing.

The user interface system 214 may receive and process user input and/or provide an interface conveying information to a user. For example, the user interface system 214 may permit a user to select multiple video clips to be combined within the interactive media asset. Additionally or alternatively, the user interface system 214 may permit the user to identify user interactions that may occur during playback of a given video clip and the result or action to be taken in response to the received interactions. In these and other embodiments, the user interface system 214 may include a display of various video clips, the order in which they are to be combined, and/or actions which the user may take in generating an interactive media asset.

The path mode system 218 may illustrate a path or flow along which the interactive media asset may progress. Additionally or alternatively, using the user interface system 214, the user may adjust, modify, or otherwise control the path or flow along which the interactive media asset may progress. For example, the user may select a transition from one video clip to another clip within the interactive media asset, and the action(s) to trigger the transition. For example, if a video is shown of a person running, a user input may cause the interactive media asset to transition to a video clip showing the person jumping over a pit, while if no input is received the interactive media asset may transition to a video clip of the person falling into the pit. The flow, order of the flow, transitions, etc. may be modified and/or adjusted via the path mode system 218.

The splicing system 220 may receive the data output by any of the user interface system 214, the path mode system 218, etc. The data may include multiple assets. Video assets are described as an example. Any type of asset, and any combination of assets may be used. The splicing system 220 may combine two or more assets. In at least one embodiment, the splicing system 220 may concatenate two or more assets to create an interactive media asset. When combing two or more assets, the splicing system 220 may also create instructions and/or metadata that a player or software development kit (SDK) may read to know how to access and play each asset. In this manner, each asset is combined while still retaining the ability to individually play each asset from within a combined file.

Each individual video asset or clip may include multiple frames and may include information that identifies a number of frames associated with the corresponding video asset or clip (e.g., a frame count for the corresponding video asset). The frame count may identify a first frame and a last frame of the corresponding video assets. The splicing system 220 may use the frames identified as the first frame and the last frame of each asset to determine transition points between the different video assets. For example, the last frame of a first video asset and a first frame of a second video asset may be used to determine a first transition point that corresponds to transitioning from the first video asset to the second video asset.

In some embodiments, the splicing system 220 may generate multiple duplicate frames of each frame identified as the last frame of corresponding video assets. For example the multiple duplicate frames of the last frame of the first video asset may be generated. The duplicate last frames may be combined into a duplicate video asset and placed in a position following the last frame of the corresponding video asset. For example, each duplicate frame of the last frame of the first video asset may be made into a first duplicate video asset and placed in a position just following the first video asset. As another example, each duplicate frame of the last frame of the second video asset may be made into a second duplicate video asset and placed in a position just following the second video asset.

The duplicate frames may be generated to account for differences in video player configurations. For example, some video players may transition to a subsequent frame immediately after playing a last frame of a video asset. As another example, some video players may wait a number of frames or a period of time (or may suffer from a delay in transition) before transitioning to a subsequent frame after playing a last frame of a video asset. The duplicate frames may be viewed by a user during this delay to prevent a cut, black scene, or an incorrect frame being noticeable to a viewer. For example, using such an approach a last frame of the person running may be shown while the video player transitions to the video of the person jumping over the pit, rather than inadvertently playing part of the clip of the person falling into the pit.

In some embodiments, the splicing system 220 may determine an updated frame count for the first frame and last frame for each video asset. For example, the updated frame count for last frame of the first video asset may be equal to the number of frames in the first video asset plus the number of frames in the duplicate first video asset. As another example, the updated frame count for last frame of the second video asset may be equal to the number of frames in the first video asset plus the number of frames in the duplicate first video set plus the number of frames in the second video asset plus the number of frames in the second duplicate video asset. As yet another example, the updated frame count for the first frame of the second video asset may be equal to the updated frame count for the last frame of the first video asset plus one.

The splicing system 220 may splice each video asset and duplicate video asset into an intermediate interactive media asset in a first particular format. In some embodiments, the splicing system 220 may concatenate each of the video assets and duplicate video assets into the intermediate interactive media asset. For example, the intermediate interactive media may be generated in a Transport Stream (TS) format or any other appropriate format. The splicing system 220 may also convert the intermediate interactive media to a second particular format. For example, the intermediate interactive media may be converted to an MPEG-4 (MP4) format or any other appropriate format. The splicing system 220, as part of converting the intermediate interactive media to the second particular format, may label the frames corresponding to the updated frame count of each first frame of the video asset as a key frame. In some embodiments, key frames may indicate a change in scenes or other important events in the intermediate interactive media asset.

In some embodiments, the designation of key frames may facilitate the navigation to and/or playing of specific video clips within the interactive media asset. For example, if three distinct video clips were being combined within the interactive media asset, an initial frame of each of the individual video clips may be designated as key frames within the combined interactive media asset.

The converter system 222 may convert the convert the interactive media to any format, such as hypertext markup language 5 (HTML5). For example, after concatenating all of the video assets and their respective reproduced frames into a single MP4 file, the MP4 file may be converted into HTML5, WebM, etc. In some embodiments, the individual video assets may be in disparate formats and may be converted to a common format for concatenation.

The preview system 224 may include a system to provide a preview of the interactive media asset. A benefit of the preview system 224 is the ability to view an interactive media asset before it is published to an application marketplace or store. The preview system 224 may receive a request, such as via a GUI, to preview the interactive media asset. In response to receiving input selecting a preview button, for example, a matrix barcode, such as a Quick Response (QR) Code may be displayed. In these and other embodiments, the matrix code may be associated with a download link to download the completed interactive media. The interactive media asset may be provided to a client device, such as the client device 102 for preview. In at least one embodiment, as updates to the interactive media asset may be made, those updates may be pushed to the client device in real time such that the client device does not need to request the preview a second time.

The publication system 226 may receive the intermediate interactive media asset. To publish the intermediate interactive media asset as the interactive media asset 228, certain identification information for or the format of the identification information of the intermediate interactive media may be required to match identification information or the format of the identification information in the corresponding app, game, or other function for an electronic device. For example, an interactive media asset may be generated, updated, or otherwise edited from the intermediate interactive media asset to match a particular format of the corresponding app, game, platform, operating system, executable file, or other function for an electronic device.

To match the identification information in the intermediate interactive media asset, the publication system 226 may receive identification information associated with the corresponding app, game, or other function for an electronic device. For example, the publication system 226 may receive format information associated with the corresponding app, game, platform, operating system, executable file, or other function for an electronic device. The publication system 226 may extract the identification information for the corresponding app, game, platform, operating system, executable file, or other function for an electronic device. In some embodiments, the identification information may include particular information that includes a list of identification requirements and unique identifiers associated with the corresponding app, game, platform, operating system, executable file, or other function for an electronic device. For example, the identification information may include Android® or iOS® requirements of the corresponding app, game, platform, operating system, executable file, or other function for an electronic device.

The publication system 226 may also open a blank interactive media project. In some embodiments, the identification information associated with the blank interactive media project may be removed from the file. In other embodiments, the identification information associated with the blank interactive media project may be empty when the blank interactive media project is opened. The publication system 226 may insert the identification information extracted from the corresponding app, game, platform, operating system, executable file, or other function for an electronic device into the blank interactive project along with the intermediate interactive media asset.

The publication system 226 may compile the blank interactive project including the intermediate interactive media asset and the identification information extracted from the corresponding app, game, platform, operating system, executable file, or other function for an electronic device. In some embodiments, the publication system 226 may perform the compiling in accordance with an industry standard. For example, the publication system 226 may perform the compiling in accordance with an SDK. The compiled interactive project may become the interactive media 228 once signed with a debug certificate, a release certificate, or both by a developer and/or a provider such as a provider associated with the application provider 104 of FIG. 1.

The publication system 226 may directly send the interactive media asset to an application store, such as the Google Play Store®, or the Apple App Store®, among others.

Modifications, additions, or omissions may be made to the application 112 without departing from the scope of the present disclosure. For example, the designations of different elements in the manner described is meant to help explain concepts described herein and is not limiting. Further, the application 112 may include any number of other elements or may be implemented within other systems or contexts than those described.

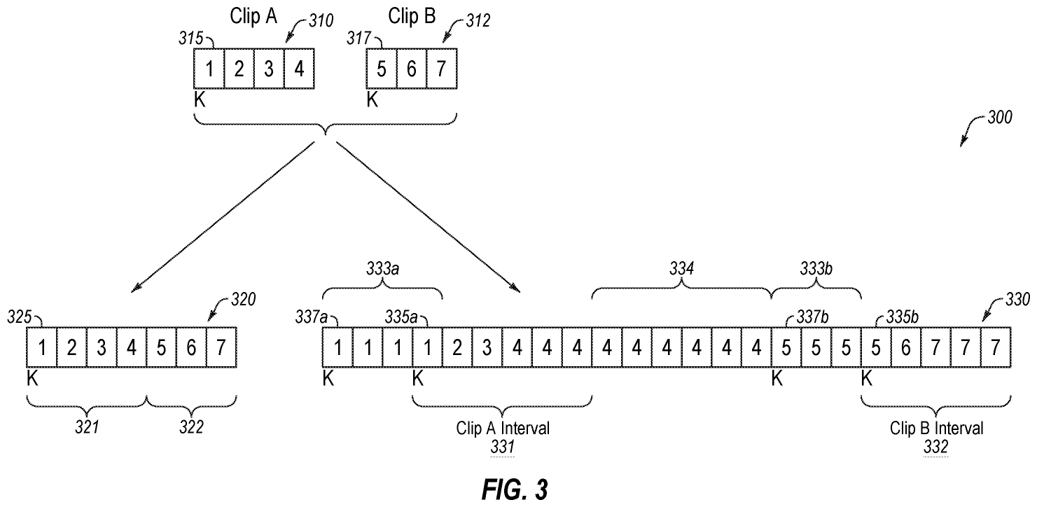

FIG. 3 illustrates various examples of portions of interactive media, in accordance with one or more embodiments of the present disclosure. As illustrated in FIG. 3, a flow 300 may illustrate a process by which one or more video clips (sch as Clip A 310 and Clip B 312) may be combined into a single interactive media asset (such as clips 320 and/or 330). The arrows from the Clips A 310 and B 312 to the clip 320 of the combined clips may illustrate one approach to combining video clips, while the arrow to the clip 330 illustrates another approach via which the Clips A 310 and B 312 may be combined in accordance with the present disclosure.

The Clip A 310 may include four frames (labeled as 1-4) with the initial frame 315 being designated as a key frame (as indicated by the K below the frame). The Clip B 312 may include three frames (labeled as 5-7) with the initial frame 317 being designated as a key frame (as indicated by the K below the frame). While the clips 310 and 312 are shown with four and three frames, respectively, the number of frames is selected for convenience in explaining the principles of the present disclosure. In some embodiments, any number of clips (e.g., tens or hundreds of individual clips) may be combined, each with any number of frames (e.g., hundreds or thousands of frames).

The clip 320 may include a concatenation of the Clip A 310 and the Clip B 312. As illustrated in the clip 320, the individual frames of the two clips (e.g., clips 321 and 322) may be placed in succession in a single video clip 320. However, in such an approach, the clip 322 may lose the indication of frame 5 as a key frame as it was when Clip B 312 was a stand-alone video clip. Because frame 5 is no longer a key frame, it would be difficult to navigate to frame 5 to play the clip 322. Additionally, if the intent was to navigate to a different clip after playing the clip 321, portions of the clip 322 may play while the video player is attempting to navigate to the different clip.

In contrast to the clip 320, the clip 330 may be combined in a manner that may resolve one or more of these issues. In some embodiments, the first frame in the Clip B 312 (e.g., the frame 335b) may be designated as a key frame. By doing so, the beginning of the Clip B 312 may be a video that may be navigated to or otherwise recalled for playing on demand and may not need to be played simply as a continuation of the Clip A 310.

Depending on the video player, the capabilities of the device providing the playback, etc., when instructing the video player to stop playing a video on the last frame of a clip, the video player may stop too early. For example, with reference to the clip 320, if the clip 321 were to be played so the video player was instructed to stop at frame 4, the video player may stop at frame 3 or frame 2. In some embodiments, to overcome this issue, the given video clip may be extended by reproducing the last frame as part of the video clip. For example, the Clip A interval 331 in the video clip 330 may include multiple reproductions of frame 4 such that if the video player is instructed to cease playing at the last frame of the Clip A interval 331 and the video player stops early (e.g., one or two frames before the end of Clip A interval 331, the final frame (frame 4) is still played. Such a result may be particularly important in the context of the present disclosure, as the last frame of a video may include textual instructions (e.g., swipe right), etc. for interacting with the interactive media asset. By extending the last frame within the interval of the specific clip, the issues associated with video players stopping too early may be addressed. While FIG. 3 illustrates frame 4 being reproduced with two additional frames, any number of additional frames may be used. Typically, the number of frames by which the last frame is extended within the Clip A interval 331 is less than ten or less than five.

When instructing a video player to navigate to another frame to play a video clip in a portion of the interactive media asset, depending on the video player and/or the hardware playing back the video, there may be a lag between the instruction and when the video player responds. For example, with reference to clip 320, if the video player were instructed to jump to frame 8 (not illustrated) to play an additional clip after finishing playing the clip 321, the video player may respond too slowly and frames 5 and 6 may play before the video player jumps to frame 8. Such an issue may cause flashes of an entirely wrong clip to play when interacting with an interactive media asset. As another example, if instructing the video player to play the clip 322 after the clip 321, the video player may play frames 1-4 and then play frames 5 and 6 before catching up and jumping back to play frames 5 and 6 again. In some embodiments, to address this issue, padding 334 may be placed at the end of the clip A interval 331 such that if the video player lags in responding, what is played is the final frame of the previous video clip. For example, with reference to the clip 330, frame 4 may be reproduced within the padding 334 such that if instructed to navigate to a new clip beginning at frame 8 (not shown) after the Clip A interval 331 has played and lag occurs, the extension of frames 4 within the padding 334 may be what is played rather than spilling over and playing frames of the Clip B interval 332 (e.g., rather than frames 5-7 playing).

Navigating to a particular clip may be difficult for certain video players and/or certain devices based on imprecision introduced by the video player and/or the device. For example, if navigating to a particular frame, the video player may over-shoot the navigation. For example, if navigating to the frame 335b at the start of the Clip B interval 332, the video player may actually navigate to frame 6 or frame 7 and may track backwards to the next key frame and may begin playing the video clip from the identified key frame. If the video player navigates to frame 6 or 7, this works reasonably well. However, due to inconsistencies in the video players and/or devices operating the video players, the video player may actual navigate to the frame just prior to the start of the video clip (e.g., with reference to the clip 320, may navigate to frame 4). In such a circumstance, the video player may track backwards to the wrong key frame (frame 1) and may play the clip 321 rather than the desired clip 322. In some embodiments, to address this issue, padding 333 of a reproduction of the initial frame of a video clip may be appended prior to the interval of the clip and the first frame of the padding 333 may be designated as a key frame. For example, with reference to the clip 330 and the Clip B interval 332, frame 5 may be reproduced in the padding 333b and the first frame of the padding 337b may be designated as a key frame. As another example, with reference to the clip 330 and the Clip A interval 331, frame 1 may be reproduced in the padding 333a and the first frame 337a of the padding may be designated as a key frame. In these and other embodiments, if the video player misses the beginning of the target video (e.g., the Clip B interval 332), the video player may track backwards within the padding 333 and may simply play the initial frame of the target video (e.g., frame 5 of Clip B interval 332) a few times prior to playing the incorrect video segment. By providing the padding 333, inconsistencies in navigating to a particular video clip may be overcome when navigating to different portions of an interactive media asset.

While described in the context of navigating to a particular frame associated with a video clip, one or more styles of video processors and/or associated devices may permit navigation using time points rather than frame numbers. For example, the beginning of the Clip B interval 332 may be at a time of 12:02.05 (twelve minutes, two seconds, and five hundredths of a second) into the interactive media asset. As indicated herein, when navigating to such a time segment, the video player may over- or under-shoot, for example, based on lag or imprecision in the video player and/or the device. Additionally, while a particular frame is identified based on frame number, in implementation, navigating to a frame may be based on a frame count for the entire interactive media asset (e.g., the beginning of the Clip A interval 331 may be frame four and the beginning of the Clip B interval 332 may be frame nineteen).

In some embodiments, such navigation may occur in response to user input. For example, the interactive media asset may include a demo of a game and the presentation of the demo may include user interaction when playing the demo that causes the interactive media asset to instruct the video player of the device to navigate to different video clips based on what has occurred within the demo of the game. In these and other embodiments, the problems introduced regarding incorrect video clips flashing or playing, etc. may be more pronounced due to the real-time interaction with the demo.

While a number of features are illustrated for the clip 330 to address a number of issues, a subset of the features may be implemented in any combination. For example, the clip 330 may or may not include the padding 334. As another example, the clip 330 may or may not include the padding 333. As a further example, the clip 330 may or may not include the extension of the terminal frame (frame 4) within the Clip A interval 331 and/or the extension of the terminal frame (frame 7) within the Clip B interval 332. As an additional example, the clip 330 may or may not designate frame 337a and/or 337b as key frames, and/or may or may not designate frame 335b as a key frame.

Modifications, additions, or omissions may be made to the flow 300 of FIG. 3, without departing from the scope of the present disclosure. For example, the designations of different elements in the manner described is meant to help explain concepts described herein and is not limiting. Further, the flow 300 may include any number of other elements or may be implemented within other systems or contexts than those described. For example, any number of video clips of any duration may be incorporated into the clip 330, with padding 334 between each of the distinct clips and/or padding 333 at the beginning of each clip.

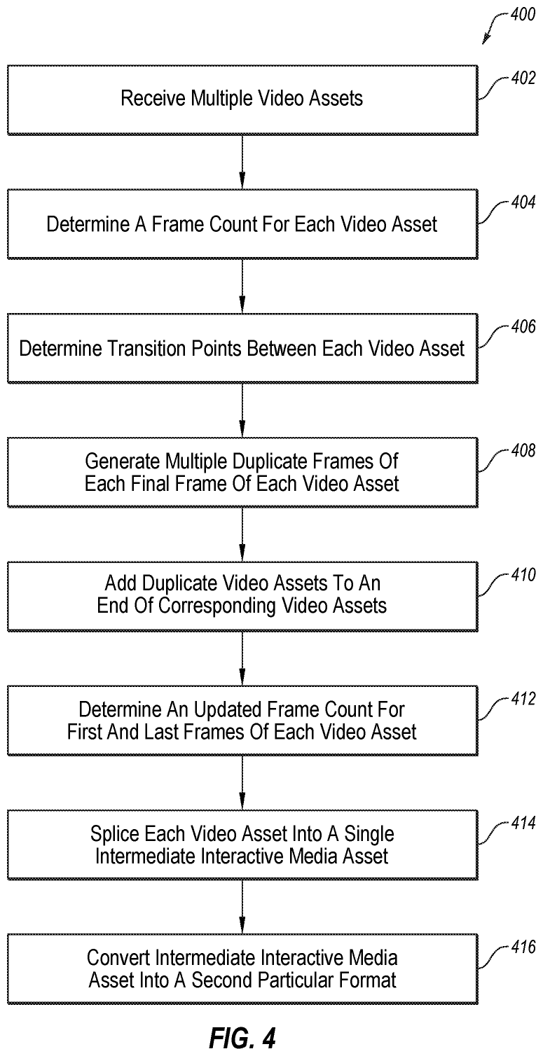

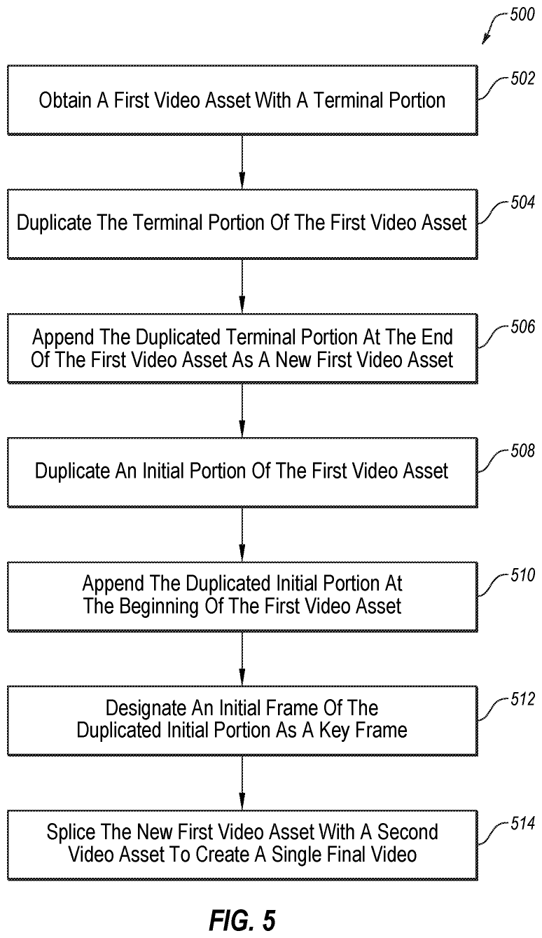

FIGS. 4-5 are flow diagrams illustrating methods for performing various operations, in accordance with some embodiments of the present disclosure, including performing editing functions of media data. The methods may be performed by processing logic that comprises hardware (e.g., circuitry, dedicated logic, programmable logic, microcode, etc.), software (e.g., instructions run on a processor to perform hardware simulation), or a combination thereof. Processing logic can control or interact with one or more devices, applications or user interfaces, or a combination thereof, to perform operations described herein. When presenting, receiving or requesting information from a user, processing logic can cause the one or more devices, applications or user interfaces to present information to the user and to receive information from the user.

For simplicity of explanation, the methods of FIGS. 4-5 are depicted and described as a series of operations. However, acts in accordance with this disclosure can occur in various orders and/or concurrently and with other operations not presented and described herein. Furthermore, not all illustrated operations may be required to implement the methods in accordance with the disclosed subject matter. In addition, those skilled in the art will understand and appreciate that the methods could alternatively be represented as a series of interrelated states via a state diagram or events.

FIG. 4 is a flow diagram illustrating a method 400 of generating an interactive media asset, in accordance with some embodiments of the present disclosure. In one implementation, method 400 may be performed by a splicing system 220, as illustrated in FIG. 2.

Referring to FIG. 4, the method 400 begins at block 402 where processing logic may receive multiple video assets or clips. For example, a user may upload, capture, or otherwise designate multiple video clips to be provided to processing logic for inclusion when generating the interactive media asset.

At block 404, the processing logic may determine a frame count for each video asset. For example, the processing logic may count the number of frames in each of the video clips to be combined into the interactive media asset. Additionally or alternatively, the processing logic may analyze metadata associated with each of the video clips to obtain the frame count of the individual clips.

In some embodiments, other pre-processing of the video assets or clips may be performed. For example, if the video clips are in different formats, they may be converted to a common format. As another example, if the video clips are at different frame rates (e.g., one clip is stored at 30 frames per second (fps) and another is stored at 60 fps), they may be converted to a common frame rate, which may be the lesser frame rate (e.g., one or both of the clips may be converted so both are at 15 or 30 fps). As an additional example, if the video clips have different aspect ratios (e.g., 4:3 vs 16:9), they may be converted to a common aspect ratio. As a further example, if the video clips have different audio formats or sources (e.g., one video has stereo audio and one has 5.1 audio), the audio of the video clips may be converted to a common audio format.

At block 406, the processing logic may determine transition points between each video asset or clip. The transition points may be where one video asset transitions to a subsequent video asset. Furthermore, the transition points may correspond to the last frame of an earlier video asset and the first frame of a subsequent video asset. For example, with reference to FIG. 3, a transition point may be identified between Clip A and Clip B.

At block 408, the processing logic may generate multiple duplicate frames of each final frame of each video asset. For example, with reference to Clip A 310 of FIG. 3, the processing logic may generate multiple duplicates of frame 4.

At block 410, the processing logic may add the duplicate video assets to ends of corresponding video assets. The duplicate video assets may be added to the ends of the corresponding video assets to compensate for differences in video players as discussed elsewhere in the present disclosure. In some embodiments, the multiple duplicate frames may be appended to the initial video asset to generate a longer video asset (e.g., the extension of frame 4 within the Clip A interval 331 of FIG. 3). Additionally or alternatively, the end frames of each video asset may be duplicated and converted into a duplicate video asset (e.g., the padding 334 of FIG. 3).

At block 412, the processing logic may determine an updated frame count for the first and last frames of each video asset. The updated frame count may account for the number of frames that were added to video assets by corresponding duplicate video assets. For example, with reference to FIG. 3, the Clip A interval 331 may include six frames while the Clip A 310 may include four frames.

At block 414, the processing logic may splice each video asset into a single interactive media asset. The splicing may include the individual videos clips and/or padding before and/or after the individual video clips. In these and other embodiments, the interactive media asset may be spliced into a first particular format. For example, each video asset may be concatenated into the interactive media asset. In these and other embodiments, the interactive media asset may include a single file or asset rather than multiple files or assets.

At block 416, the processing logic may convert the interactive mediate asset into a second particular format. The second particular format may be different than the first particular format. For example, if originally in an MP4 format, the interactive media asset may be converted to an HTML5 format. In these and other embodiments, the splicing of the video clips and the transition between formats may provide a significant space savings in file size of the interactive media asset.

Modifications, additions, or omissions may be made to the method 400 without departing from the scope of the disclosure. For example, the operations of the method 400 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 5 is a flow diagram illustrating a method 500 of generating an interactive media asset, in accordance with some embodiments of the present disclosure. In one implementation, method 500 may be performed by a splicing system 220, as illustrated in FIG. 2 to generate an interactive media asset.

Referring to FIG. 5, the method 500 begins at block 502 where a first video asset with a terminal portion may be obtained. For example, a user may upload, capture, or otherwise designate the first video asset or clip to be provided to processing logic for inclusion when generating an interactive media asset.

At block 504, the terminal portion of the first video asset may be duplicated. In these and other embodiments, the terminal portion may include the last frame in the first video asset and the last frame may be duplicated multiple times.

At block 506, the duplicated terminal portion may be appended at the end of the first video asset as a new first video asset. For example, the duplicated terminal portion may be included at the end of the first video asset such that the interval for the new first video asset includes the duplicated terminal portion. As another example, the duplicated terminal portion may be appended at the end of the first video asset while still maintaining the previous first video asset interval. In some embodiments, the terminal portion may be duplicated, and the interval may be adjusted to include the duplicated terminal portion, and the duplicated terminal portion may also be appended to the end of the first video asset outside of the interval of the first video asset as padding between the first video asset and a subsequent video asset. In these and other embodiments, the duplicated last frame within the interval may include two additional copies of the last frame, and the duplicated last frame outside of the interval may include six additional copies of the last frame.

At block 508, an initial portion of the first video asset may be duplicated. For example, the first frame of the first video asset may be duplicated multiple times.

At block 510, the duplicated initial portion may be appended at the beginning of the first video asset and/or at the beginning of the new first video asset. In these and other embodiments, the duplicated initial portion may be appended but outside of the interval of the first video asset and/or the new first video asset. In some embodiments, the duplicated initial portion may include three additional copies of the initial frame of the first video asset.

At block 512, an initial frame of the duplicated initial portion may be designated as a key frame.

At block 514, the new first video asset may be spliced with a second video asset to create a single final video as at least part of the interactive media asset. An example of such a spliced final video may be illustrated as the video clip 330 of FIG. 3.

Modifications, additions, or omissions may be made to the method 400 without departing from the scope of the disclosure. For example, the operations of the method 400 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

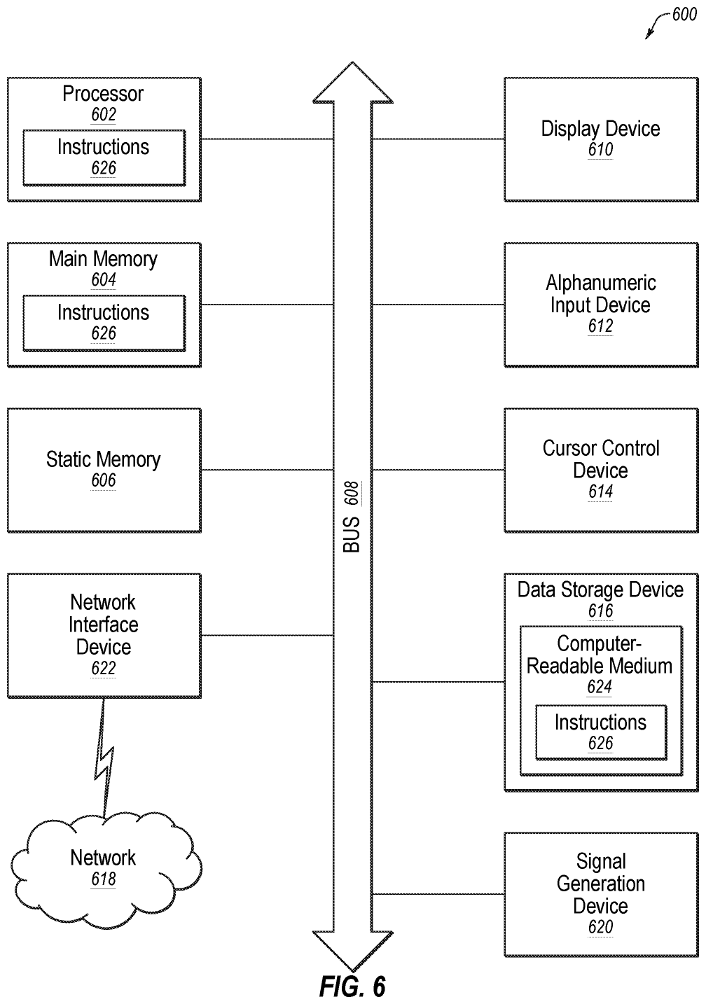

FIG. 6 illustrates a diagrammatic representation of a machine in the example form of a computing device 600 within which a set of instructions, for causing the machine to perform any one or more of the methodologies discussed herein, may be executed. The computing device 600 may be a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and/or a signal generation device 620 (e.g., a speaker). In one implementation, the display device 610, the alphanumeric input device 612, and/or the cursor control device 614 may be combined into a single component or device (e.g., an LCD touch screen).

The data storage device 616 may include a computer-readable storage medium 624 on which is stored one or more sets of instructions 626 embodying any one or more of the methodologies or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example embodiment to be a single medium, the term “computer-readable storage medium” should be taken to include a single medium or multiple media (e.g., a centralized or distributed database and/or associated caches and servers, etc.) that store the one or more sets of instructions 626. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “subscribing,” “providing,” “determining,” “unsub scribing,” “receiving,” “generating,” “changing,” “requesting,” “creating,” “uploading,” “adding,” “presenting,” “removing,” “preventing,” “playing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
obtaining a first video asset with a first number of frames, the first video asset including a terminal portion of at least one frame;
duplicating the terminal portion of the first video asset;
appending the duplicated terminal portion at the end of the first video asset as a new first video asset; and
splicing the new first video asset with a second video asset to create a single final video.

2. The method of claim 1, further comprising:
duplicating an initial portion of the first video asset; and
appending the duplicated initial portion of the first video asset at the beginning of the first video asset.

3. The method of claim 2, further comprising designating an initial frame of the duplicated initial portion as a key frame such that both the initial frame of the duplicated initial portion and an original initial frame of the first video asset are both designated as key frames in the final video.

4. The method of claim 1, wherein duplicating the terminal portion of the first video asset includes making multiple copies of the terminal portion.

5. The method of claim 4, wherein at least one of the multiple copies of the terminal portion is included within an interval of the first video asset and more than one copy of the terminal portion is included as padding between the interval of the first video asset and an interval of the second video asset.

6. The method of claim 1, wherein the terminal portion is one frame.

7. The method of claim 1, wherein the first video asset includes a first number of frames per second and the second video asset includes a second number of frames per second different from the first number of frames per second, and the single final video is at a lesser of the first number of frames per second or the second number of frames per second.

8. One or more non-transitory computer-readable media containing instructions that, in response to being executed by one or more processors, cause a system to perform operations comprising:
obtaining a first video asset with a first number of frames, the first video asset including a terminal portion of at least one frame;
duplicating the terminal portion of the first video asset;
appending the duplicated terminal portion at the end of the first video asset as a new first video asset; and
splicing the new first video asset with a second video asset to create a single final video.

9. The computer-readable media of claim 8, wherein the operations further comprise:
duplicating an initial portion of the first video asset; and
appending the duplicated initial portion of the first video asset at the beginning of the first video asset.

10. The computer-readable media of claim 9, wherein the operations further comprise designating an initial frame of the duplicated initial portion as a key frame such that both the initial frame of the duplicated initial portion and an original initial frame of the first video asset are both designated as key frames in the final video.

11. The computer-readable media of claim 8, wherein duplicating the terminal portion of the first video asset includes making multiple copies of the terminal portion.

12. The computer-readable media of claim 11, wherein at least one of the multiple copies of the terminal portion is included within an interval of the first video asset and more than one copy of the terminal portion is included as padding between the interval of the first video asset and an interval of the second video asset.

13. The computer-readable media of claim 8, wherein the terminal portion is one frame.

14. The computer-readable media of claim 8, wherein the first video asset includes a first number of frames per second and the second video asset includes a second number of frames per second different from the first number of frames per second, and the single final video is at a lesser of the first number of frames per second or the second number of frames per second.

15. A system comprising:
one or more processors; and
one or more non-transitory computer-readable media containing instructions that, in response to being executed by one or more processors, cause the system to perform operations comprising:
obtaining a first video asset with a first number of frames, the first video asset including a terminal portion of at least one frame;
duplicating the terminal portion of the first video asset;
appending the duplicated terminal portion at the end of the first video asset as a new first video asset; and
splicing the new first video asset with a second video asset to create a single final video.

16. The system of claim 15, wherein the operations further comprise:
duplicating an initial portion of the first video asset; and
appending the duplicated initial portion of the first video asset at the beginning of the first video asset.

17. The system of claim 16, wherein the operations further comprise designating an initial frame of the duplicated initial portion as a key frame such that both the initial frame of the duplicated initial portion and an original initial frame of the first video asset are both designated as key frames in the final video.

18. The system of claim 15, wherein duplicating the terminal portion of the first video asset includes making multiple copies of the terminal portion.

19. The system of claim 18, wherein at least one of the multiple copies of the terminal portion is included within an interval of the first video asset and more than one copy of the terminal portion is included as padding between the interval of the first video asset and an interval of the second video asset.

20. The system of claim 15, wherein the terminal portion is one frame.
